(19) United States
(12) Patent Application Publication
(10) Pub. No.: US 2002/0066025 A1
(43) Pub. Date: May 30, 2002

(54) Music distribution method

(76) Inventors: Tatsuro Sato, Chiba-shi (JP); Isao Arai, Chiba-shi (JP); Katsuhiko Fuse, Chiba-shi (JP); Yosuke Kanno, Chiba-shi (JP); Ken Mutou, Chiba-shi (JP); Satoshi Tsuchiya, Chiba-shi (JP)

Correspondence Address: ADAMS & WILKS, 31st Floor, 50 Broadway, New York, NY, 10004, US

(21) Appl. No.: 09/953,636

(22) Filed: Sep. 17, 2001

(30) Foreign Application Priority Data
Sep. 12, 2000 (JP) 2000-276694
Sep. 6, 2001 (JP) 2001-270282

(51) Int. Cl. G06F 12/14

(52) U.S. Cl. 713/200

(57) ABSTRACT

There is provided a music distribution method capable of performing high-security music data distribution at high speed through the internet or other such network, wherein music data is divided into insufficient data and add-on data (step S101), the insufficient data, a restoration program and a communications program are written in a read-only fashion into a ROM section of a medium and the medium is distributed (steps S110-104), then the add-on data and such are distributed through the internet or the like (step S105) to be recorded into a RAM section of the medium and the music data is restored, producing a result that music may be regenerated on a terminal device.

### BACKGROUND OF THE INVENTION

1. Field of the Invention

The present invention relates to a music distribution method, and particularly to a music distribution method for distributing music through the internet or other such network.

2. Description of the Related Art

There is known a conventional music distribution method in which encoded music data is recorded onto a CD-ROM and a key for decoding this code is distributed through the internet or other such network.

However, with a conventional music distribution method such as the one above, there is a risk that the key for decoding the code will be broken. Further, if the code is decoded all of the music data may be copied easily, so there is the danger that rights protecting the music data cannot be protected.

### SUMMARY OF THE INVENTION

The present invention has been made in light of the above, and has as an object to provide a music distribution method capable of performing high-security music data distribution at high speed through the internet or other such network.

In order to solve the above-mentioned problems and to achieve this object, a music distribution method according to a first aspect of the present invention is characterized by comprising the steps of: dividing music data into insufficient data lacking a part of the music data and add-on data corresponding to the lacking part of this insufficient data; recording the insufficient data on a computer readable storage medium; and distributing the add-on data through a network to return the add-on data to the insufficient data on a computer, whereby restoring the original music data.

Further, according to a second aspect of the present invention, in the first aspect of the invention, the music distribution method is characterized by further comprising the steps of: in the insufficient data recording step, recording the insufficient data in a read-only section of a storage medium having the read-only section and a readable/writable section; and in the add-on data distribution step, recording the distributed add-on data in the readable/writable section of the storage medium.

Further, according to a third aspect of the present invention, in the first aspect of the invention, the music distribution method is characterized by further comprising the step of recording onto the storage medium a restoration program for restoring the original music data by returning the add-on data to the insufficient data on the computer.

Further, according to a fourth aspect of the present invention, in the second aspect of the invention, the music distribution method is characterized by further comprising the step of recording onto the storage medium a restoration program for restoring the original music data by returning the add-on data to the insufficient data on the computer.

Further, according to a fifth aspect of the present invention, in the fourth aspect of the invention, the music distribution method is characterized in that the read-only section of the storage medium is a storage medium defined by the restoration program as a read-only area, the insufficient data is recorded onto this read-only section defined by the restoration program, and the add-on data is distributed through the network to return the add-on data to the insufficient data on the computer, whereby the original music data is restored.

Further, according to a sixth aspect of the present invention, in the third aspect of the invention, the music distribution method is characterized in that a specific position of the insufficient data recorded in the storage medium is recorded in the restoration program.

Further, according to a seventh aspect of the present invention, in the fourth aspect of the invention, the music distribution method is characterized in that the restoration program is stored in the read-only section of the storage medium, and simultaneously, a specific position of the restoration program itself is recorded.

Further, according to an eighth aspect of the present invention, in the first aspect of the invention, the music distribution method is characterized by further comprising the step of recording onto the storage medium a communications program for downloading the add-on data to a computer which has read the insufficient data from the storage medium storing the insufficient data.

Further, a music distribution method according to a ninth aspect of the present invention is characterized by comprising the steps of: dividing music data into insufficient data lacking a part of the music data and add-on data corresponding to the lacking part of this insufficient data; distributing through a network the insufficient data, the add-on data, and a restoration program for returning the add-on data to the insufficient data on a computer.

Further, a music distribution method according to a tenth aspect of the present invention is characterized by comprising the steps of: dividing music data into insufficient data lacking a part of the music data, and add-on data corresponding to the lacking part of this insufficient data; encoding the add-on data; distributing through a network the insufficient data, the encoded add-on data, and a restoration program for returning the add-on data to the insufficient data on a computer; and distributing through the network a decoding key for decoding the encoded add-on data.

Further, according to an eleventh aspect of the present invention, in the first aspect of the invention, the music distribution method is characterized in that the add-on data is specific bit information from a time when the music data underwent A/D conversion.

Further, according to a twelfth aspect of the present invention, in the first aspect of the invention, the music distribution method is characterized in that the add-on data is specific frequency information among the music data.

Further, according to a thirteenth aspect of the present invention, in the first aspect of the invention, the music distribution method is characterized in that the add-on data is specific displacement information from among the music data.

### BRIEF DESCRIPTION OF THE DRAWINGS

In the accompanying drawings:

FIG. 1 is a diagram of a construction of a system f or realizing a music distribution method according to an embodiment;

FIG. 2 is a block diagram depicting a functional construction of hardware of a terminal device for realizing the music distribution method according to the present embodiment of the invention;

FIG. 3 is a conceptual diagram of a medium for realizing the music distribution method according to the present embodiment of the invention;

FIG. 4 is a block diagram depicting a specific example of the functional construction of the hardware of the terminal device for realizing the music distribution method according to the present embodiment of the invention;

FIG. 5 is a block diagram depicting a specific example of a functional construction of hardware of a server for realizing the music distribution method according to the present embodiment of the invention;

FIG. 6 is a flow chart of the music distribution method;

FIG. 7 is a conceptual diagram of the music distribution according to the embodiment of the invention; and

FIG. 8 is a conceptual diagram of a specific pattern of a dividing step.

### DETAILED DESCRIPTION OF THE PREFERRED EMBODIMENTS

Hereinafter, detailed explanation will be made of a music distribution method according to a preferable embodiment of the present invention, with reference to the attached drawings. Note that the present invention is not limited by the embodiments.

(System Construction)

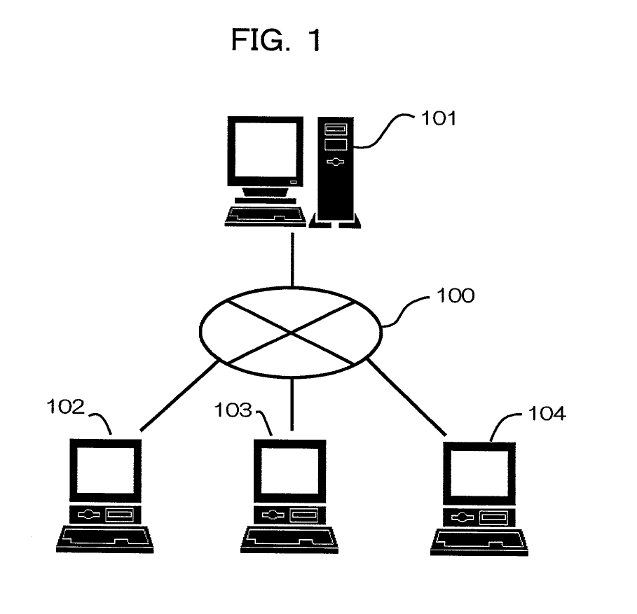

FIG. 1 is a diagram of a construction of a system for realizing a music distribution method according to an embodiment. In FIG. 1, the system for realizing the music distribution method according to the present embodiment is comprised of a server 101 and terminal devices 102, 103, 104, etc. all of which are respectively connected to the internet or other such network 100. The server 101 and the terminal devices 102 are realized by a computer such as a portable-type computer or personal computer, workstation, or such being capable of reading from and writing to removable storage media.

Note that the removable storage media (hereinafter referred to as “media”) are media which are easily removed from the computer main body, and have a read-only section (sometimes indicated as a ROM section) and a readable/writable section (sometimes indicated as a RAM section), as described below. These media include, for example, disk-form media such as CD-RW, DVD-RAM, DVD-RW and DVD+RW, and memory media such as flash memory, compact flash, smart media, memory sticks and SD cards.

(Functional Construction)

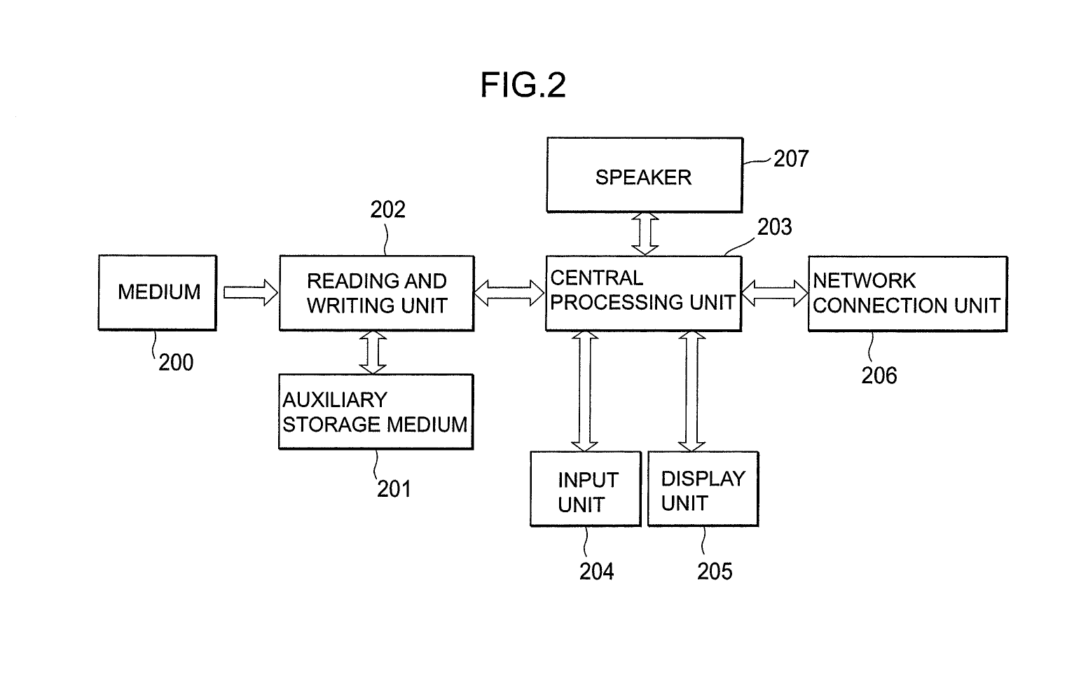

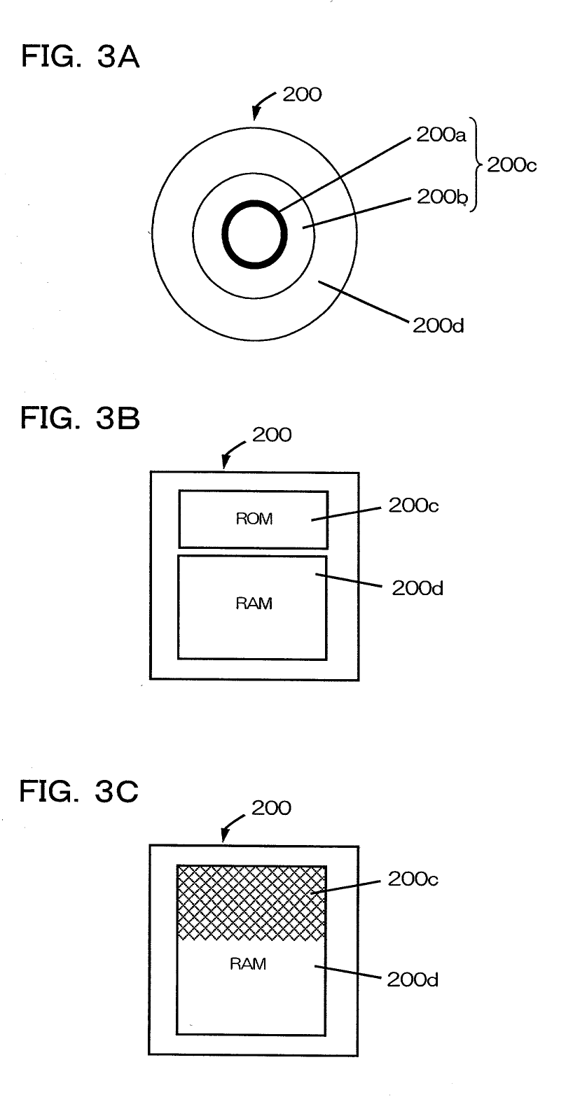

Next, explanation will be made of a functional construction of hardware for realizing the music distribution method according to the embodiment of the present invention. FIG. 2 is a block diagram depicting a functional construction of hardware of a terminal device for realizing the music distribution method according to this embodiment of the present invention. FIGS. 3A to 3C are conceptual diagrams of media for realizing the music distribution method according to this embodiment of the present invention.

In FIG. 2, reference numeral 200 denotes a medium; 201, an auxiliary storage medium; 202, a reading and writing unit (hereinafter abbreviated as “read-write unit”); 203, a central processing unit; 204, an input unit; 205, a display unit; and 2061, a network connection unit.

The medium 200 has a read-only section 200a only for being read by a computer and a readable/writable section 200b which can be written to and read from by the computer. The read-only section 200a stores a communications program, a restoration program and an insufficient program, for example, which contain a communications utility, an access number for a communications destination, communications negotiations, etc. The readable/writable section 200b stores downloaded add-on data and the like.

Returning to FIG. 2, an auxiliary storage medium 201 stores a temporary record and other various data. The read-write unit 202 performs reading and writing to and from the medium 200 and the auxiliary storage medium 201. In particular, this read-write unit 202 reads programs and data written onto the read-only section 200a and the readable/writable section 200b.

FIGS. 3A to 3C are diagrams for explaining the concept of the medium 200 for realizing a network connection method according to the embodiment of the present invention; FIG. 3A depicts the case of a disk medium, and FIGS. 3B and 3C depict the case of a memory medium.

On the disk-form medium 200 of FIG. 3A, there are arranged the read-only section 200c and the readable/writable section 200d, and the read-write unit 202 reads the program or data written on the read-only section 200c and the readable/writable section 200d.

On the medium 200 of FIG. 3B using a memory element, there are arranged the read-only section 200c comprised of a ROM (i.e., read only memory) element, and the readable/writable section 200d comprised of a RAM (i.e., random access memory) element.

The medium 200 of FIG. 3C using a memory element is composed of a RAM (random access memory) element, and the operating system (OS) or other such base software, or the restoration program for restoring the music data defines a specific area within the element as the read-only section 200c, and the other area functions as the readable/writable section 200d. (In the case where the restoration program for restoring the music data performs the definition, each area functions as a read-only section and a readable/writable section in the operations of the restoration program).

Further, the read-write unit 202 writes the add-on data received through the network connection unit 206 and that is a part of the music data, and the other various data received through the network connection unit 206 onto the readable/writable section 200b of the medium 200. That is, the various data such as this add-on data are downloaded from the server 101 when the connection is made to the internet or other such network 100, and written to the readable writable section 200d.

The central processing unit 203 governs the overall processing. In particular, this central processing unit 203, as described below, executes the various programs read out from the medium 200 for realizing functions of the various steps, connects to the internet or other such network 100 and downloads the add-on data and the like, and also, as described below, restores the music data and regenerates the music. The input unit 204 is a mouse or other such pointing device, or a keyboard or other such input device. The display unit 205 is a CRT (Cathode Ray Tube), or liquid crystal or other such display.

The network connection unit 206 obeys the network connection program executed by the central processing unit 203, and connects to the server 101 through the internet or other such network 100 (see FIG. 1). Then, this network connection unit 206 receives from the server 101 through the network 100 the add-on data that is a part of the music data, as explained below. Additionally, this network connection unit 206 sends various data to the server 101. Further, a speaker 207 outputs the regenerated music.

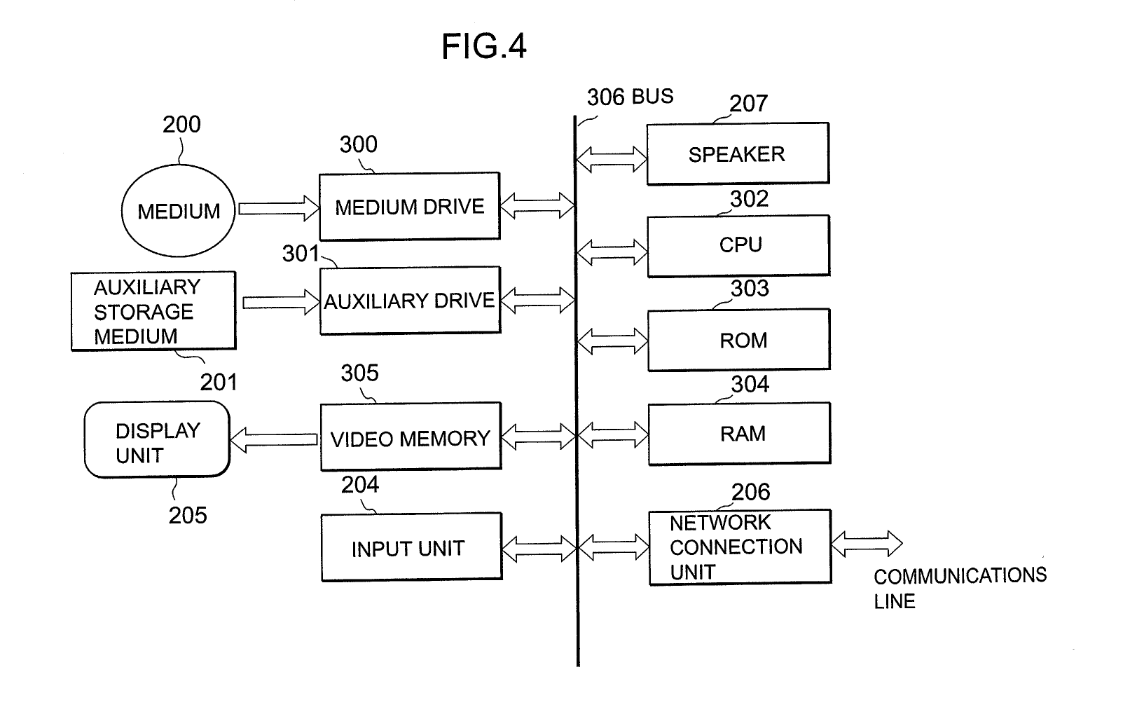

Next, explanation will be made of a particular example of a functional construction of hardware of a terminal device for realizing the music distribution method according to the present embodiment of the invention. FIG. 4 is a block diagram depicting the specific example of the functional construction of the hardware of the terminal device for realizing the music distribution method according to this embodiment of the present invention. Note that the same reference numerals are applied to the components that are identical to the components of FIG. 2 described above.

In FIG. 4, a media drive 300 and an auxiliary drive 301 realize the functions of the read-write unit 202. The media drive 300 reads out the various data from the read-only section 200c and the readable/writable section 200d of the medium 200, and also, performs reading and writing of data to and from the readable/writable section 200d. The auxiliary drive 301 performs reading and writing of data to and from the auxiliary storage medium 201.

Further, a CPU 302, a ROM 303 and a RAM 304 realize the functions of the central processing unit 203. The CPU 302 executes, in order, various programs, various data of which have read out from the ROM 303 and the RAM 304. In the ROM 303, particularly, there is stored a program for reading the booting unit 200a of the medium 200. In the RAM 304 the various programs and other such data which have been read from the read-only section 200c and the readable/writable section 200d of the medium 200.

Further, a video memory 305 holds display area data corresponding to the screen of the display unit 205. To a bus 306 there are connected the media drive 300, the auxiliary drive 301, the CPU 302, the ROM 303, the RAM 304, the video memory 305, the input unit 204, the network connection unit 206, and the speaker 207 respectively.

With the above construction, at the terminal device 102 (103, 104) the communications program is read out from the read-only section 200a of the medium 200 and executed, the connection is made to the server 101, the add-on data is downloaded and recorded in the readable/writable section, the restoration program and the insufficient data are read out, the add-on data is added to the insufficient data to restore the original music data, and the music is regenerated from the speaker 207.

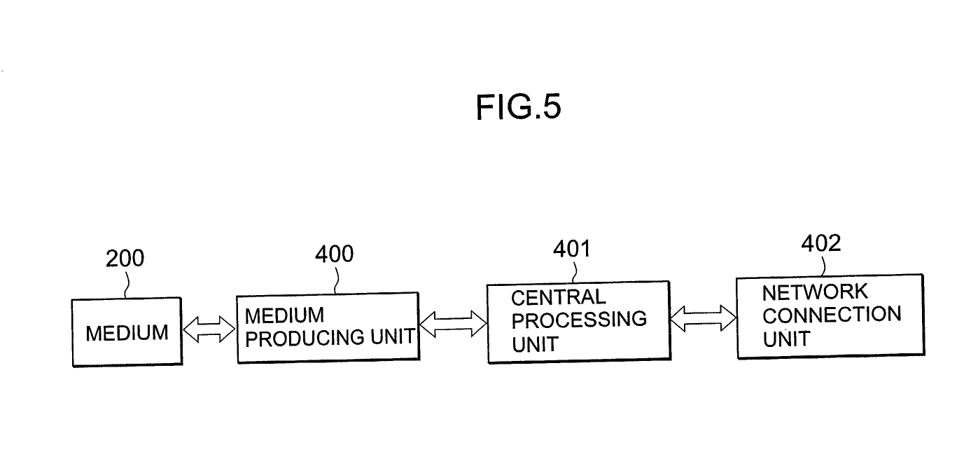

Next, explanation will be made of the functional construction of hardware of a server for realizing the music distribution method according to the present embodiment of the invention. FIG. 5 is a block diagram depicting the functional construction of the hardware of the server for realizing the music distribution method according to the present embodiment of the invention. Note that the same reference numerals are used for the elements that are the same as the above elements. Reference numeral 400 denotes a medium producing unit for producing the medium 200. Reference numeral 401 denotes a central processing unit for governing controls as a whole, and the CPU, which is not depicted in the figure, executes the program stored in the ROM or RAM, which are not depicted in the figure, whereby executing the program for realizing the music distribution method.

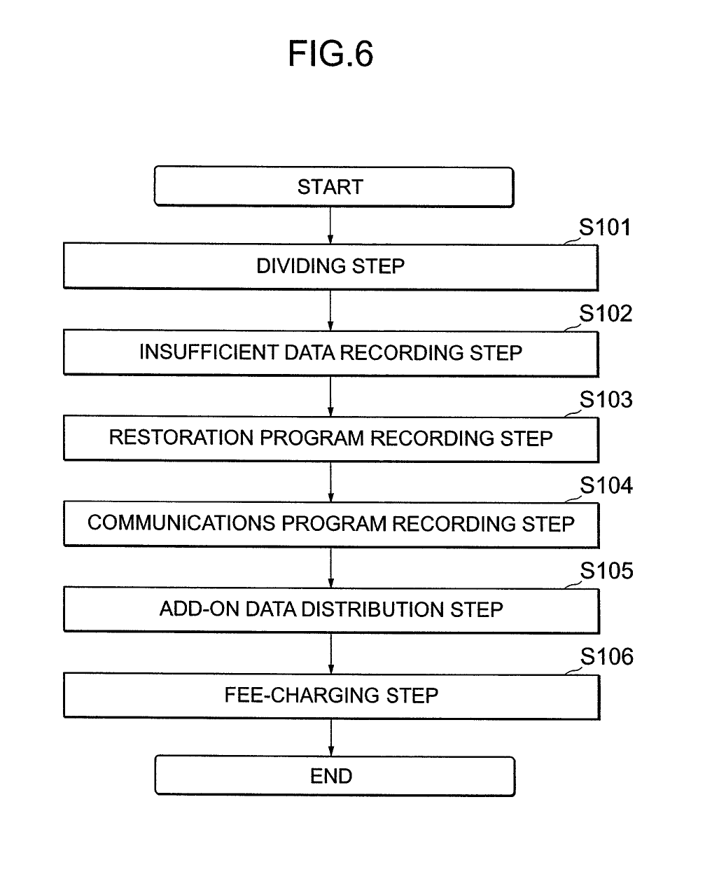

Next, explanation will be made of the flow of the music distribution method executed by the server 101. FIG. 6 is a flow chart of the music distribution method. First, the central processing unit 401 divides the music data into the insufficient data and the add-on data (step S101). Next, the central processing unit 401 stores the insufficient data, the restoration program and the communications program in the read-only section 200a (see FIG. 3) by means of the media producing unit 400, and produces the medium 200 (steps S101-S104).

Also, the central processing unit 401 distributes the add-on data and the like through the internet or other such network 100 to the terminal device 102 (103, 104) (step S105), which has already received the medium 200 in advance. Accordingly, the regeneration of the music on the terminal device 102 (103, 104) side becomes possible. Finally, the distribution of the add-on data enables the central processing unit 401 to calculate a sum to be charged to the distribution destination, and the central processing unit 401 records this sum, and also, sends a bill amount to the distribution destination (step S106). Accordingly, it becomes possible to perform a collection of a charge for the distribution each time the music is distributed.

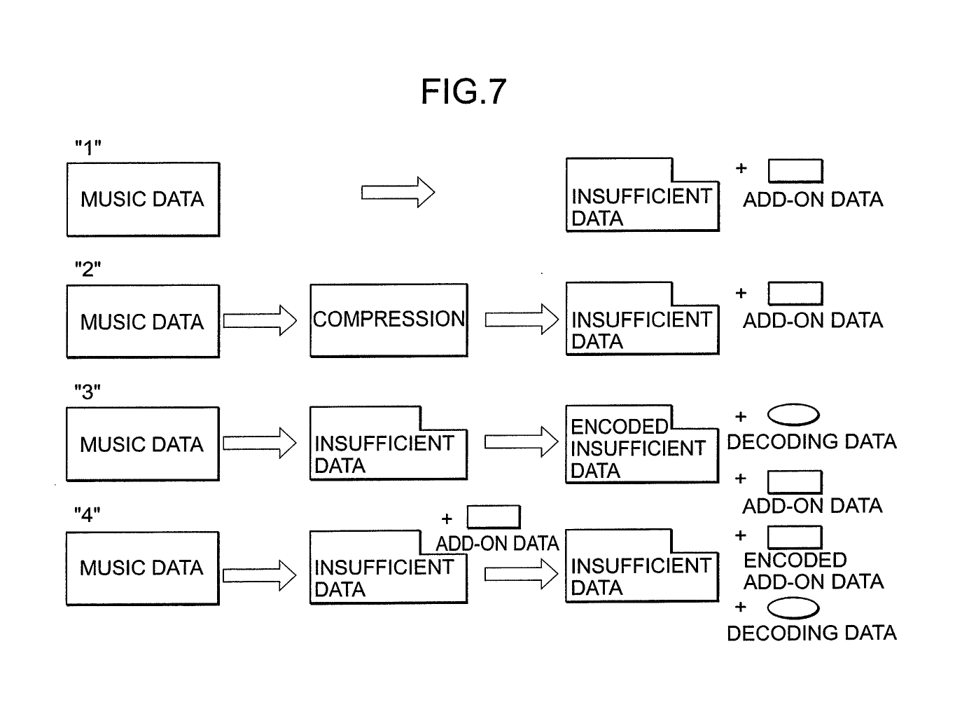

Next, explanation will be made of a concept of the music distribution according to the present embodiment of the invention. FIG. 7 is a conceptual diagram of the music distribution according to the embodiment of the invention. “1” in FIG. 7 is the concept of the music distribution described above, and it is the case in which the music data is divided into insufficient data and add-on data. “2” is the case in which the music data is divided into insufficient data and add-on data after compression of the music data. In this case, the amount of insufficient data to be written into the read-only section 200a of the medium 200 in advance may be smaller. Further, since the amount of the add-on data may also be smaller the communication speed becomes faster.

“3” is the case in which the music data is divided into insufficient data and add-on data, and the insufficient data is coded and written into the read-only section 200a, and also, decoding data for decoding the code is distributed with the add-on data through the network 100, the add-on data is added to the insufficient data after the insufficient data code is decoded using the decoding data, and thus the music data is restored. In this way, encoding the insufficient data improves the security of the medium 200.

“4” is the case in which the music data is divided into insufficient data and add-on data, and the insufficient data is written into the read-only section 200a, and also, the add-on data is encoded, the decoding data for decoding the encoded add-on data is distributed with the add-on data through the network 100, the add-on data is added to the insufficient data after the add-on data code is decoded using the decoding data, and thus the music data is restored. In this case, the security is further improved by using a method such as one in which, for example, the decoding data is distributed in advance and after that the encoded data is distributed, encoding data is used as a public key and the add-on data is encoded using a private key and then distributed, or the encoding data is used as a private key and a public key is disclosed when a request is received for distribution of the add-on data and this public key is used to encode the add-on data at the same time that the data is distributed.

In FIG. 7, inside the program for restoring the music data there recorded specific data from the insufficient data written in the read-only section 200a, such as a storage location and an ID for recording, and the music data may only be restored when the insufficient data is at a predetermined position. This produces the result that in the case where the insufficient data and the data necessary for the restoration of the music data is reproduced on another medium, or the like, it is impossible to restore the music, so it becomes possible to prevent illegal copying and the like.

Additionally, when the program for restoring the music data is written into the read-only section 200a, the specific data of the program itself which is written into the read-only section 200a, such as the storage position and the ID for recording, are recorded at the same time as the program, and the music is to be restored only when this program itself is at the predetermined position, which produces the result that it is impossible to reproduce or move the program for restoring the music data to another medium or such. Therefore, in the case when this program is reproduced the music cannot be restored, which means that when the music is to be listened to, it is absolutely necessary to use the medium in which the program for restoration is, so it becomes possible to render copies of the data meaningless per se and prevent illegal copying and the like.

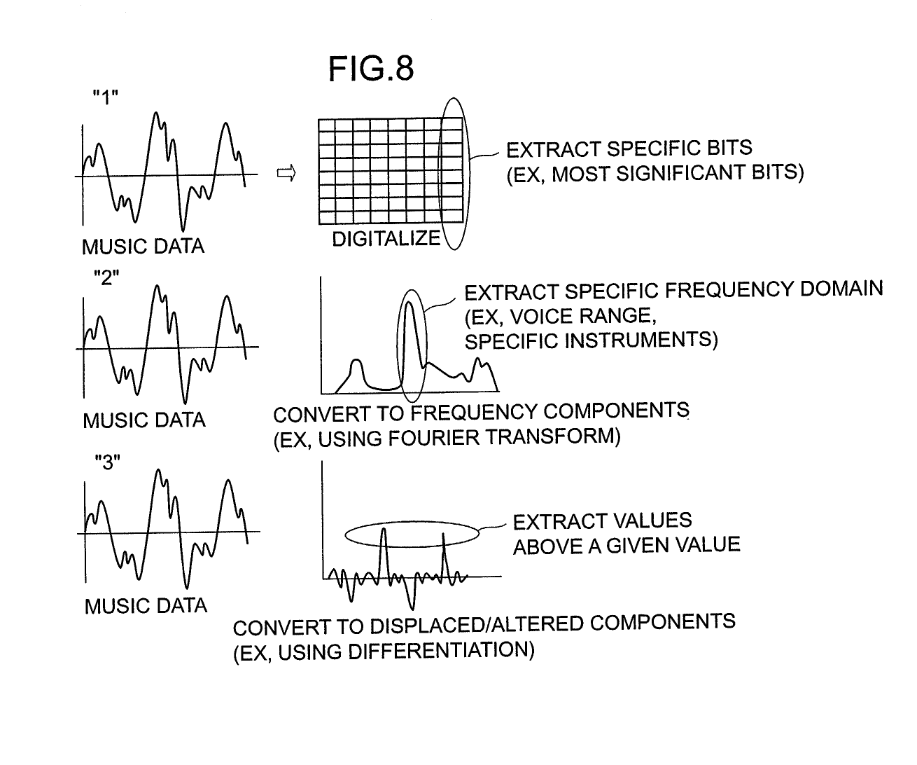

Finally, explanation will be made of a specific concept of patterns of a dividing step. FIG. 8 is a conceptual diagram of specific patterns of the dividing step.

“1” is the case in which the music data is converted from an analog wave pattern to a digital one, and after that, specific bits such as the most significant bits are extracted, producing the result that the insufficient data and the add-on data can be divided in a regulated fashion. Note that in this case it is also possible to perform this regular division after performing a compression. By performing the compression it is possible to make the data non-decompressable.

“2” is the case in which the music data is converted into frequency components by means of Fourier transform, and a specific frequency domain is extracted. The specific frequency domain may be, for example, the frequency domain around a voice range or of a part where certain instruments or the like indicate a peak. In this manner, it becomes possible to extract the voice range and certain instruments and the like, which enables elimination of qualities of musicality.

With this method it is still possible to perform regeneration of just the insufficient data, but musicality has been lost, whereby achieving a characteristic that the insufficient data alone is made to have no value as music.

“3” is the case in which the music data is converted into displaced and altered components by means of differentiation or the like, and a portion being equal to or greater than a freely chosen value is extracted.

Accordingly, it becomes possible to extract portions of the music conveying a sense of modulation and continuity, and the quality of musicality is eliminated or regeneration becomes impossible, for example.

Note that in the above embodiment, the restoration program for restoring the music data has been described to download all the add-on data before restoring, but it may store a restoration application being only for real time use for performing the restoration in real time while the add-on data is being downloaded. Accordingly, the restoration of the music data cannot be performed except while downloading the add-on data, and thus the prevention of illegal copying becomes possible.

As explained above, according to the present embodiment, even if the user has a distributed medium 200, the music cannot be regenerated without downloading the add-on data through the internet or other such network, so it becomes possible to perform music distribution with a high level of security. Further, by applying a charge with the downloading of the add-on data, it becomes possible to provide music distribution for a fee. Further, the distribution of the add-on data can be performed with a smaller amount of data than in the case where all of the music data is distributed via the internet or other such network, and so the amount of time for communications can be made shorter.

As described above, according to the present invention, an effect is produced such that even if the user has a distributed medium, the music cannot be regenerated without downloading the add-on data through the internet or other such network, so it becomes possible to perform music distribution with a high level of security. Further, by applying a charge with the downloading of the add-on data, it becomes possible to provide music distribution for a fee.

What is claimed is:

1. A music distribution method characterized by comprising the steps of:
dividing music data into insufficient data lacking a part of the music data and add-on data corresponding to the lacking part of said insufficient data;
recording the insufficient data on a computer readable storage medium; and
distributing the add-on data through a network, and returning the add-on data to the insufficient data on a computer, whereby restoring the original music data.

2. A music distribution method according to claim 1, further comprising the steps of: in the insufficient data recording step, recording the insufficient data in a read-only section of the storage medium having the read-only section and a readable writable section, and
in the add-on data distribution step, recording the distributed add-on data in the readable/writable section of the storage medium.

3. A music distribution method according to claim 1, further comprising the step of recording onto the storage medium a restoration program for restoring the original music data by returning the add-on data to the insufficient data on the computer.

4. A music distribution method according to claim 2, further comprising the step of recording onto the storage medium a restoration program for restoring the original music data by returning the add-on data to the insufficient data on the computer.

5. A music distribution method according to claim 4, wherein the read-only section of the storage medium is a storage medium defined by the restoration program as a read-only area; the insufficient data is recorded onto this read-only section defined by the restoration program; and the add-on data is distributed through the network to return the add-on data to the insufficient data on the computer, whereby the original music data is restored.

6. A music distribution method according to claim 3, wherein a specific position of the insufficient data recorded in the storage medium is recorded in the restoration program.

7. A music distribution method according to claim 4, wherein the restoration program is stored in the read-only section of the storage medium, and simultaneously, a specific position of the restoration program itself is recorded.

8. A music distribution method according to claim 1, further comprising the step of recording onto the storage medium a communications program for downloading the add-on data to a computer which has read the insufficient data from the storage medium storing the insufficient data.

9. A music distribution method comprising the steps of:
dividing music data into insufficient data lacking a part of the music data and add-on data corresponding to the lacking part of said insufficient data; and
distributing through a network the insufficient data, the add-on data, and a restoration program for returning the add-on data to the insufficient data on a computer.

10. A music distribution method comprising the steps of:
dividing music data into insufficient data lacking a part of the music data and add-on data corresponding to the lacking part of the insufficient data;
encoding the add-on data;
distributing through a network the insufficient data, the encoded add-on data, and a restoration program for returning the add-on data to the insufficient data on a computer; and
distributing through the network a decoding key for decoding the encoded add-on data.

11. A music distribution method according to claim 1, wherein the add-on data is specific bit information from a time when the music data underwent A/D conversion.

12. A music distribution method according to claim 1, wherein the add-on data is specific frequency information among the music data.

13. A music distribution method according to claim 1, wherein the add-on data is specific displacement information from among the music data.
